(19) United States
(12) Patent Application Publication
(10) Pub. No.: US 2006/0018518 A1
(43) Pub. Date: Jan. 26, 2006

(54) Method and device for determining the three-dimension position of passengers of a motor car

(76) Inventors: Martin Fritzsche, Biberach (DE); Tilo Schwarz, Elchingen (DE)

Correspondence Address: PENDORF & CUTLIFF, 5111 MEMORIAL HIGHWAY, TAMPA, FL, 33634-7356, US

(21) Appl. No.: 10/534,245

(22) PCT Filed: Dec. 4, 2003
(86) PCT No.: PCT/EP03/13685

§ 371 Date: May 9, 2005

(30) Foreign Application Priority Data
Dec. 12, 2002 (DE) 102 57 963.6

(51) Int. Cl. G06K 9/00

(52) U.S. Cl. 382/116

(57) ABSTRACT

The invention relates to a method for determining a three-dimensional position of passengers of a motor vehicle. The inventive method consists in observing the passengers of the vehicle with the aid of at least two cameras (1, 2, 1′, 2′) which are disposed in such a way that they can operate in non-stereo mode, extracting the appropriate characteristics of the passengers from video data, initialising tracking by means of a head model, verifying said extracted characteristics by pattern recognition and in tracking said verified characteristics by means of said head model. The inventive device based on a store controller which is used for carrying out said method is also disclosed.

### BACKGROUND OF THE INVENTION

1. Field of the invention

The present invention generally relates to a method and a device for determining the three-dimensional position and, in particular, a method and a device for determining the three-dimensional head position and/or head attitude of a driver or passenger of a motor vehicle. The method according to the invention and the device according to the invention, respectively, are particularly suitable for recognizing the direction of view of a driver or passenger of a motor vehicle and for detecting fatigue. In addition, the method according to the invention and the device according to the invention, respectively, provide a possibility for determining the state of the eyelids of a driver or passenger of a motor vehicle.

2. Related Art of the Invention

Methods for linking a number of sensors for determining the three-dimensional position of objects in space are known in connection with so-called virtual reality methods. In these methods, for example, an electromagnetic tracking system records, on the one hand, the head position and the direction of sight of a user which is called head tracking. On the other hand, the electromagnetic tracking system records the position of a three-dimensional input device (e.g. pen, three-dimensional joystick, data glove etc.). These three-dimensional input devices provide a user with the ability of directly interacting with the data, i.e. he has the possibility of moving in the virtual world and touching, rotating and scaling the data objects.

From the prior art, stereo methods for detecting the direction of view of vehicle passengers are also known, for example FaceLab™ by the company Seeingmachines.

From U.S. Pat. No. B1-6,324,453, a method for detecting and determining the position of a motor vehicle driver or passenger is known in which an IR sensor or a multiplicity of IR sensors are used. The IR sensors are used for detecting the motor vehicle driver to be monitored. The detected information is evaluated by means of predetermined patterns in order to utilize the position of the driver or passenger for a controlled release of the airbag. This type of control is intended to prevent the driver or passenger from becoming injured in the case of an accident-related release of the airbag. The pattern recognition is performed with the aid of a neural network or of a neural fuzzy system which detects the motor vehicle passengers. In some applications according to U.S. Pat. No. B1-6,324,453, the pattern recognition system is equipped with a picture library which allows a comparison to be made with the detected images, as a result of which a relatively accurate determination of the position of the seated motor vehicle passenger is possible, which avoids the head position from having to be detected.

A device for determining the head position of a motor vehicle passenger in the presence of objects which mask the line of sight from sensors to the head of the passenger is known from U.S. Pat. No. B1-6,088,640. The device from U.S. Pat. No. B1-6,088,640 is constructed for positioning the headrests of a motor vehicle optimally with respect to the head position of a passenger by means of stepping motors in order to prevent the passengers from becoming injured in the case of a collision with a following motor vehicle. In one embodiment of U.S. Pat. No. A1-6,088,640, the sensor system for determining the head position of a vehicle passenger consists of an ultrasonic transmitter, an ultrasonic receiver and a contact sensor which are all mounted in a headrest of the motor vehicle. The ultrasonic sensors determine the distance of the head from the rest and regulate its position until the distance assumes a minimum value. The ultrasonic sensors also determine the length of the distance of the headrest to the head of the passenger. The latter determination can supply wrong results due to the inaccurate alignment of the head with the ultrasonic sensors or by interfering objects such as, for example, hat, collar or hairstyle of the passenger. This error source is eliminated by stopping the movement of the headrest when the head comes into contact with the contact sensor. It is thus possible to determine an optimum position of the headrest. In a modification, U.S. Pat. No. B1-6,088,640 provides an ultrasonic transmitter and three ultrasonic receivers, and the head position is detected by means of a neural network or another pattern recognition system. This arrangement comprising a multiplicity of ultrasonic receivers which are arranged at a multiplicity of positions on the headrest allows the head position to be detected even in the presence of an obstacle as mentioned above.

### SUMMARY OF THE INVENTION

Considering the prior art, it is an object of the present invention to provide a method and a device for determining three-dimensional positions which determine the head position of vehicle passengers reliably and in a simple manner by using more than one camera.

Within the context of the above object, a further object of the invention consists in providing a method and a device for detecting the direction of view of a passenger of a motor vehicle. In addition, an additional object of the present invention consists in providing a method and a device for detecting and tracking the eyelids of vehicle passengers.

This object and other objects found in the subsequent description are provided by means of a method which, for determining the three-dimensional position of vehicle passengers, comprises the following steps: observing the vehicle passengers by means of at least two cameras which are disposed in such a way that they can operate in non-stereo mode; extracting appropriate characteristics from the detected video data of the vehicle passengers; initializing a tracking step by means of a head model; verifying the extracted characteristics by means of pattern recognition; and tracking the verified characteristics by means of the head model.

The device according to the invention for determining the three-dimensional position of vehicle passengers comprises the following: at least two cameras for observing the vehicle passengers, which are disposed in such a way that they can operate in non-stereo mode; and a controller comprising the following: means for extracting appropriate characteristics from the detected video data of the vehicle passengers; means for initializing a tracking step by means of a head model; means for verifying the extracted characteristics by means of pattern recognition; and means for tracking the verified characteristics by means of the head model.

Further advantageous features of the invention are stated in the attached subclaims.

### BRIEF DESCRIPTION OF THE DRAWINGS

Further features and advantages of the present invention and the structure and operation of various embodiments of the present invention will be described below with reference to the accompanying drawings. The accompanying drawings illustrate the present invention and, together with the description, are also used for explaining the principles of the invention and enabling an expert in the relevant field to implement and to use the invention. In the figures:

FIG. 1 shows a diagrammatic representation of a first embodiment of the device according to the invention; and

FIG. 2 shows a diagrammatic representation of a second embodiment of the device according to the invention.

### DETAILED DESCRIPTION OF THE INVENTION

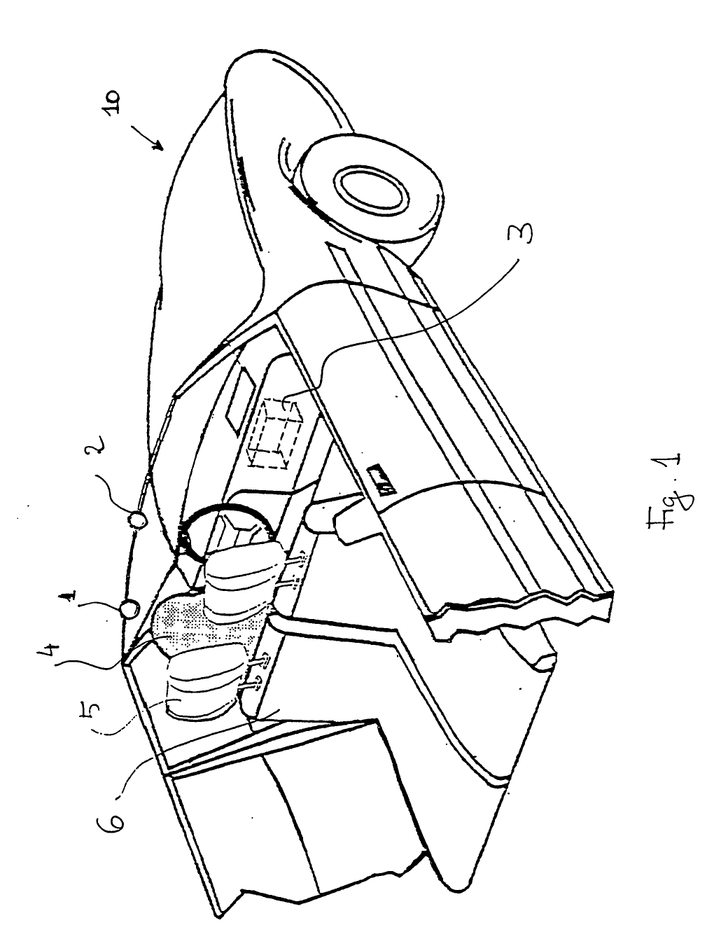

Referring to FIG. 1, a first embodiment of the device according to the invention for determining the head position of vehicle passengers is shown in which two cameras 1 and 2 are mounted as shown in the front area of a vehicle 10 shown diagrammatically. In a particularly preferred embodiment of the invention, the cameras can also be mounted in such a manner that they are directly in front of the field of view of the driver, particularly are mounted on the instrument panel. Cameras 1 and 2 can be permanently aligned or can be aligned in each case to a driver and a passenger with the aid of actuating motors, not shown. In this case, either the cameras must be calibrated, for example with the aid of a checkerboard pattern, or the mutual position and orientation of the cameras must be known. It is conceivable to provide in each case one pair of cameras for the driver and the passenger. Cameras 1 and 2 are connected by a suitable connection or transmission link (e.g. glass fiber, Bluetooth, WLAN, wiring or the like) to a controller 3, shown dashed, which, for example, can be implemented in the on-board computer of the vehicle 10.

According to an important aspect of the present invention, cameras 1 and 2 do not necessarily have to be operated in a stereo mode. Cameras 1 and 2 are also not necessarily synchronized. It is possible, therefore, to position cameras 1 and 2 with different fields of view, in such a manner that one eye of a driver 4 is always visible. According to the invention, this positioning is not problematic since the field of view of the pair of cameras 1 and 2, as mentioned, does not necessarily need to correspond to a stereo mode so that the field of view can be much greater than in the case of a stereo mode.

For example, cameras 1 and 2 can be operated in the visible range or in the IR range. However, it is also possible to use imaging sensors operating in other wavelength ranges analogously to the operation according to the invention.

Controller 3 receives the video data from cameras 1 and 2, extracts appropriate facial or shape characteristics of the passenger (e.g. eyes, nostrils, corners of the mouth, eyebrows, hairline, etc.) and carries out a tracking method, known per se, which will be explained in the text which follows in conjunction with the operation of the device according to the invention.

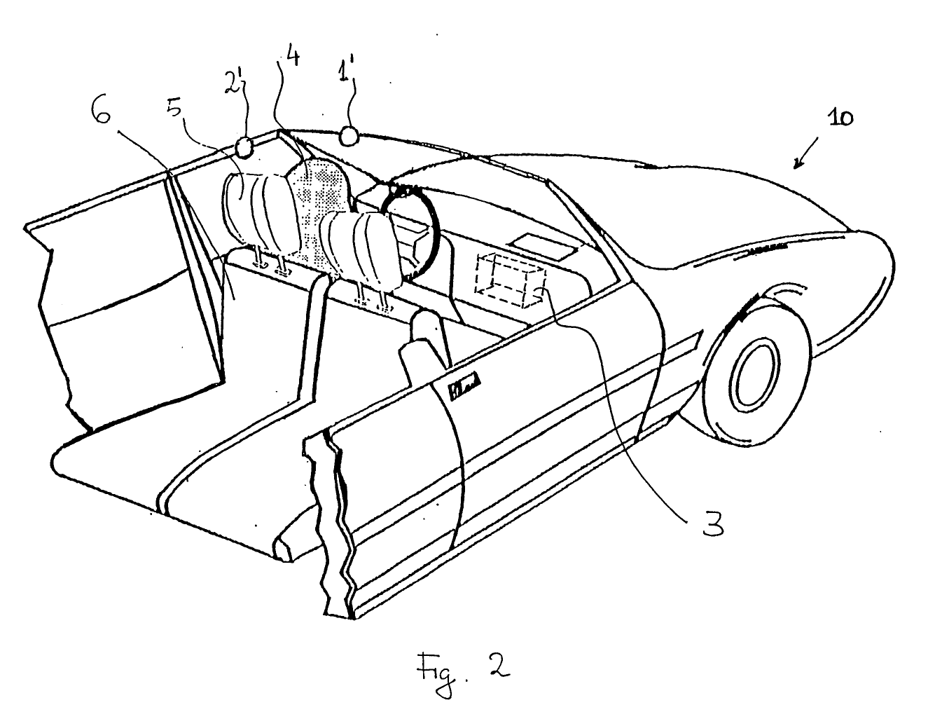

Referring to FIG. 2, a second embodiment of the device according to the invention for determining the head position of vehicle passengers is shown in which a first camera 1′ is mounted in the front area of the vehicle 10 shown diagrammatically and a second camera 2′ is mounted as shown in its side area.

Analogously to FIG. 1, cameras 1′ and 2′ of FIG. 2 can be permanently aligned or in each case aligned to the driver, the passenger or a further passenger with the aid of actuating motors, not shown. According to the invention, cameras 1′ and 2′ of FIG. 2 are also disposed in such a way that it can operate in non-stereo mode and are also not necessarily synchronized. Thus, a greater field of view is provided as in the arrangement of FIG. 1.

The operation of the embodiments of FIGS. 1 and 2 as described hereinafter is identical.

Firstly, in a first step according to the invention, the passenger or the passengers of the vehicle are recorded with cameras disposed in such a way that they can operate in non-stereo mode. In this manner, the cameras are not necessarily synchronized.

In a second step, facial or shape characteristics of the passenger or passengers of the motor vehicle, particularly the eyes, the nostrils, the corners of the mouth, the eyebrows, the hairline or the like are extracted according to the present invention.

In a further step, a tracking method is initialized by means of an anthropometric model of the head. According to the invention, a tracking method according to Greg Wech and Gary Bishop has been found particularly advantageous which is described in “SCAAT: Incremental Tracking with Incomplete Information”, 1996, University of North Carolina at Chapel Hill, CB 3175, Sitterson Hall, Chapel Hill, N.C., 27599-3175 or “One-Step-at-a-Time Tracking”, 1996, University of North Carolina at Chapel Hill, CB 3175, Sitterson Hall, Chapel Hill, N.C., 27599-3175. These tracking methods according to the prior art provide a much improved rate of estimation and latency, improved accuracy and an improved framework for combining data which originate from a multiplicity of sensors (cameras) which are not necessarily synchronized. The contents of the two abovementioned publications by Wech et al. are herewith completely included by reference. Both publications are available as TR96-051 and, respectively, TR96-021, at www.cs.unc.edu/.

According to the invention the tracking is based on Kalman filtering of all recorded characteristics and the cameras do not necessarily need to be synchronized as in the case of the stereo mode. In the case of asynchronous operation using a number of cameras, a multiplicity of pictures can be advantageously recorded in the same time in accordance with the number of cameras.

In a further step, the detected characteristics are verified by means of methods of statistical pattern recognition according to the present invention. In this case, known pattern recognition methods such as, for example, neural networks, neural fuzzy systems and pattern recognition systems with picture library are used which are partially implemented in accordance with the prior art described in the introduction to the present description.

The verification step is followed by a tracking step of the verified characteristics by means of the head model.

In a further embodiment of the method according to the invention, detection of the direction of view or determining the state of the eyelids of the passenger or passengers is performed by means of known methods. From this, fatigue detection associated with corresponding warning steps can also be derived. According to a further aspect of the method according to the invention, the head attitude of the passenger or passengers can be detected.

The present invention has a multiplicity of practical applications some of which are enumerated by way of example in the text which follows.

Thus, the determination of the three-dimensional head position of driver or passenger enables, for example, the airbag to be released according to the given situation. The release of the airbag can be prevented in dependence on the detected position by the controller 3 if there is a risk of injury to the driver or passenger in this position.

Determination of the head attitude and of the direction of view of the passengers, respectively, in interaction with environmental sensors normally used in the vehicle, allows the driver and possibly the passenger to be warned according to the given situation.

Knowledge of the state of the eyes (open/closed) can be used for fatigue detection. The blinking rate of the eyes extracted from the video data can also be used for this purpose.

Precise determination of the three-dimensional head position allows the headrest 5 to be adaptively adjusted for individually optimizing the passenger safety. The device according to the invention and the method according to the invention overcome the problems known from U.S. Pat. No. B1-6,088,640 which can arise due to the inaccurate alignment of the head with the sensors or due to interfering objects.

Furthermore, the seat 6 can be automatically individually adjusted when the eye position is known.

In addition, the invention can be used for operating a videophone for telematic applications in the vehicle. Recognition of the facial characteristics of the driver for the purpose of authentication would also be conceivable.

The present invention can be altered in many ways. Thus, for example, the number and position of the cameras shown in FIGS. 1 and 2 can be changed without departing from the protective range of the invention. In this connection, it is conceivable to use more than one pair of cameras, each pair pointing at one of the vehicle passengers and disposed in such a way, that they can operate in a non-stereo mode. As already mentioned, it is also conceivable to use pairs of cameras which can be swivelled.

If features in the claims are provided with reference symbols, these reference symbols are only there to provide a better understanding of the claims. Accordingly, such reference symbols do not represent any restrictions in the protective range of such elements which are characterized by such reference symbols only by way of example.

1. A method for determining the three-dimensional position of vehicle passengers which comprises the following steps:
observing the vehicle passengers by means of at least two cameras (1, 2, 1′, 2′) which are disposed in such a way that they can operate in non-stereo mode;
extracting appropriate characteristics from the recorded video data of the vehicle passengers;
initializing a tracking method by means of a head model;
verifying the extracted characteristics by means of pattern recognition; and
tracking the verified characteristics by means of the head model.

2. The method as claimed in claim 1, wherein the characteristics are selected from a group which consists of facial or shape characteristics of the passengers.

3. The method as claimed in claim 2, wherein the facial or shape characteristics comprise eyes, nostrils, corners of the mouth, eyebrows or hairline.

4. The method as claimed in claim 1, wherein the cameras (1, 2, 1′, 2′) do not need to be synchronized.

5. The method as claimed in claim 1, wherein the cameras (1, 2, 1′, 2′), having different fields of view, are positioned in such a manner that one eye of a driver (4) is always visible.

6. The method as claimed in claim 1, which furthermore comprises the step of determining the head attitude of passengers.

7. The method as claimed in claim 1, which also comprises the step of determining the direction of view of passengers.

8. The method as claimed in claim 1, which also comprises the step of determining the state of the eyelids of the passengers.

9. The method as claimed in claim 1, wherein the tracking step is based on the Kalman filtering of all recorded characteristics of the cameras (1, 2; 1′, 2′), wherein the cameras can be operated asynchronously.

10. The method as claimed in claim 1, wherein the head model is an anthropometric model.

11. The method as claimed in claim 1, wherein the pattern recognition is a statistical pattern recognition.

12. A device for determining the three-dimensional position of vehicle passengers, comprising:
at least two cameras (1, 2, 1′, 2′) for observing the vehicle passengers, which are disposed in such a way that they can operate in non-stereo mode; and
a controller (3) comprising the following:
means for extracting appropriate characteristics from the recorded video data of the vehicle passengers;
means for initializing a tracking step by means of a head model;
means for verifying the extracted characteristics by means of pattern recognition; and
means for tracking the verified characteristics by means of the head model.

13. The device as claimed in claim 12, wherein the characteristics are selected from a group which consists of facial or shape characteristics of the passengers.

14. The device as claimed in claim 13, wherein the facial or shape characteristics comprise eyes, nostrils, corners of the mouth, eyebrows or hairline.

15. The device as claimed in claim 12, wherein the cameras (1, 2, 1′, 2′) do not need to be synchronized.

16. The device as claimed in claim 12, wherein the cameras (1, 2, 1′, 2), having different fields of view, are positioned in such a manner that one eye of a driver (4) is always visible.

17. The device as claimed in claim 12, which also comprises means for determining the head attitude of passengers.

18. The device as claimed in claim 12, which also comprises means for determining the state of the eyelids of the passengers.

19. The device as claimed in claim 12, wherein the means for tracking are constructed for carrying out the Kalman filtering of all recorded characteristics of the cameras (1, 2; 1′, 2′), wherein the cameras can be operated asynchronously.

20. The device as claimed in claim 12 wherein the cameras (1, 2) are arranged in the front area of the vehicle (10).

21. The device as claimed in claim 12, wherein one camera (1′) is arranged in the front area and the other camera is arranged in the side area of the vehicle (10).

22. The device as claimed in claim 12, wherein the controller (3) also comprises means for controlling the release of an airbag and/or the adjustment of a head rest (5) and/or the adjustment of a seat of the vehicle by means of the detected head position.
